(19) United States
(12) Patent Application Publication
(10) Pub. No.: US 2008/0250332 A1
(43) Pub. Date: Oct. 9, 2008

(54) SOCIAL NETWORKING WEBSITE INTERFACE

(75) Inventors: Bradley Farrell, Hicksville, NY (US); Josh Silverman, Longbeach, NY (US); Michael Ciasullo, Bayside, NY (US)

Correspondence Address: PROSKAUER ROSE LLP, ONE INTERNATIONAL PLACE, BOSTON, MA, 02110, US

(73) Assignee: eCirkit, Westbury, NY (US)

(21) Appl. No.: 11/967,963

(22) Filed: Dec. 31, 2007

Related U.S. Application Data
(60) Provisional application No. 60/882,752, filed on Dec. 29, 2006.

(51) Int. Cl. G06F 3/00; G06F 15/16

(52) U.S. Cl. 715/753; 709/204

(57) ABSTRACT

Computerized methods and systems are provided for enabling electronic introductions of users of an online community. In one embodiment, a user may select a subset of users in his social network via a graphical or web interface to request that they be introduced. These users can be introduced electronically and invited or made to join each other's respective social networks.

### CROSS-REFERENCE TO RELATED APPLICATION

This application claims the benefit of and priority to U.S. provisional patent application 60/882,752 filed Dec. 29, 2006, which is owned by the assignee of the instant application and the disclosure of which is incorporated herein by reference in its entirety.

### FIELD OF THE INVENTION

The present invention relates generally to social networking and allowing users to make new social contacts. In particular, the present invention relates to systems and methods for introducing users within an electronic social networking system.

### BACKGROUND

Prior art social networking websites, such as MySpace.com allow users to maintain personal web pages and communicate with other users. Millions of people currently use these websites, making them an important part of modern socialization and networking. However, there are several drawbacks to the common implementations.

For instance, many prior art websites use basic HTTP constructs that require users to navigate between pages with their browsers by loading a new page each time a user wants to access or submit information. This makes the interaction with the website feel slow and distinct from interactions with user's PC desktop. With the amount of time many people spend interacting with networking sites, it is desirable to have an interface that flows seamlessly.

Another drawback with many networking sites is that they make it relatively simple to interact with people you already know, but don't provide effective ways to network with people that you are separated from by a social degree (e.g. people that are friends with your friends, but whom you do not currently know.) Harnessing the relationship others already have presents a real opportunity to make new and meaningful friendships.

### SUMMARY OF THE INVENTION

According to one aspect, a social networking system facilitates electronic introduction of two individuals by a mutual contact or friend, each being a user of the system. The system displays a client interface, such as a webpage, to a first user that presents a plurality of displayable user objects representing the user's contacts or friends. The user selects a plurality of the displayable user objects to select a plurality of contacts or friends and initiates an association between the selected contacts or friends. The system sends a request to a server to initiate an electronic introduction between the selected contacts or friends. In some embodiments, the system indicates to one or more of the selected contacts or friends that the first user would like to introduce her to the other selected contacts or friends. In some embodiments, the system allows the one or more of the selected contacts or friends to accept or confirm the introduction, for instance by using the client interface. In some embodiments, the system adds the selected contacts or friends to the groups of contacts or friends associated with the users in the selected contacts or friends. In some embodiments, the client interface is implemented using asynchronous web development techniques, such as AJAX.

According to another aspect, the system provides a method for enabling electronic introductions of users of an online community. The system displays a web interface to a first user that presents a plurality of displayable user objects, each representing at least one member of the first user's social network. The system enables the first user to select at least two of the plurality of displayable user objects that represent a plurality of users within the first user's social network. The first user requests via the web interface to introduce the indicated plurality of users. The system adds at least one of the indicated plurality of users to the social network associated with another of the indicated plurality of users. In some embodiments, one or more of the indicated plurality of users is notified that the first user would like to introduce her to other users. In some embodiments, after being notified of the request, the second user may accept the invitation to meet other users, such as by using the web interface. In some embodiments, the selected users are added to each other's social network. In some embodiments, the first user can monitor the progress of the introduction. In some embodiments, the first user invites members of his social network to meet each other by dragging and dropping user objects representing the users he would like to introduce. In some embodiments, the web interface interacts with a server asynchronously, such as via AJAX techniques.

According to another aspect, the system provides a method for enabling electronic introductions of users of an online community. The system maintains information that associates three groups of friends or users with a first, second, and third user. A server receives a request to initiate an electronic introduction between a subset of members of the first user's group that includes at least the second user and the third user. The system updates the information to include the third user in the second user's group. In some embodiments, the server maintains a record of the request, and may allow the first user to monitor the progress of the request. In some embodiments, the second user receives and invitation to add the third use to her group of friends or to join the third user's group of friends. In some embodiments, the third user is not added to the second user's group or the second user added to the third user's group unless she accepts.

According to another aspect, a social networking website provides a user interface that allows the user to navigate, load, edit, and perform other interactions without having to load new pages each time. The interface also enables a user to invite two or more other users to meet each other by clicking and dragging avatars, icons, pictures, logos, or other graphical user objects associated with the users into a designated area of the screen. In some embodiments, as a result, the selected users receive a notification of the invitation to meet and interact with the other user. In some embodiments, the invitation can be declined or accepted by each user. In some embodiments, the notification includes contact information of each other user such as a hyperlink to a personal profile page of the other user. In some embodiments, the progress of the invitation can be monitored by the user setting up the invitation or by other users.

### BRIEF DESCRIPTION OF THE DRAWINGS

FIG. 1 is a schematic view of a site map associated with prior art social networking websites.

FIG. 2 is a schematic view of a site map associated with a social networking website in accordance with an embodiment of the invention.

FIG. 3 is a schematic view of a user interface for use in accordance with an embodiment of the invention.

FIG. 4 is a flow chart of the operation of client and server components of an embodiment of a social networking system.

FIG. 5 is a schematic view of client and server components of an embodiment of a social networking system.

FIG. 6 is a block diagram of data object for use with an embodiment of a social networking system.

### DETAILED DESCRIPTION OF THE INVENTION

Embodiments of the invention support a networking website that acts as a web-based communications tool with business and social applications. Embodiments provide a multi-level networking (MLN) site that employs asynchronous communication between the client browser and the server using, for example, AJAX. Asynchronous retrieval and submission of information allows the networking website to look and function more like a desktop application than a website.

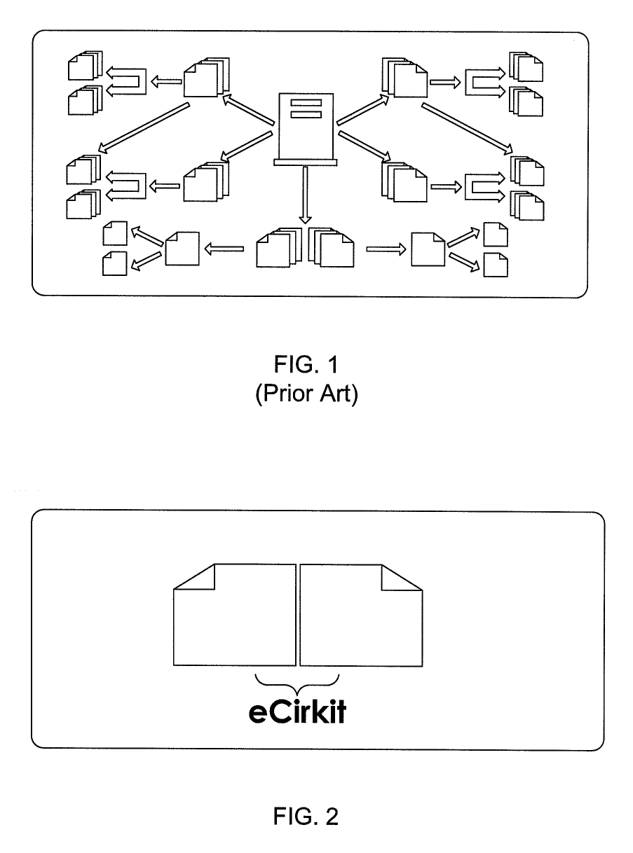

FIG. 1 is a schematic view of a site map associated with prior art social networking websites. It resembles complex flow diagrams representing hundreds (if not thousands of pages).

FIG. 2 is a schematic view of an embodiment of a site map associated with a social networking website in accordance with an embodiment of the invention. In some embodiments, the website is only 2 pages—a control panel and a profile page. The user does not have to click through unwanted pages to reach his destination, and no refreshing is needed by virtue of AJAX. From the browser's perspective, therefore, only two URLs will be visited by the user when interacting with a user interface. This allows the user to perform many tasks and actions from a single control panel page, without ever refreshing an entire webpage. The asynchronous methodology can be applied consistently throughout the entire site. In some embodiments, built on a two-page model, the system operates such that a user will only refresh if and when they visit a different profile page. In some embodiments, the website can be defined as one page or as any number of desired pages. For example, a user's control panel and profile page could be accessed using a single page or URL. A person of ordinary skill in the art will appreciate that AJAX allows the client webpage to interact with a server by sending and retrieving information in the background without requiring full page refresh or requesting a new web page. Thus the user is generally unaware that information is being served remotely and the page can behave much like a desktop application. A person of ordinary skill in the art will also appreciate that other techniques and web design methodologies that allow the webpage displayed to the user to refresh and retrieve information asynchronously could also be used to implement a website in accordance with an embodiment of the invention. In some embodiments, a website is implemented using a traditional synchronous web development methodology such that entire pages are requested from the user interface.

A social networking website in accordance with an embodiment of the invention provides a user network having members that socialize. Members/users can maintain groups for topical discussion. Members/users can maintain groups of friends that they have a closer relationship with they might have with members of a forum.

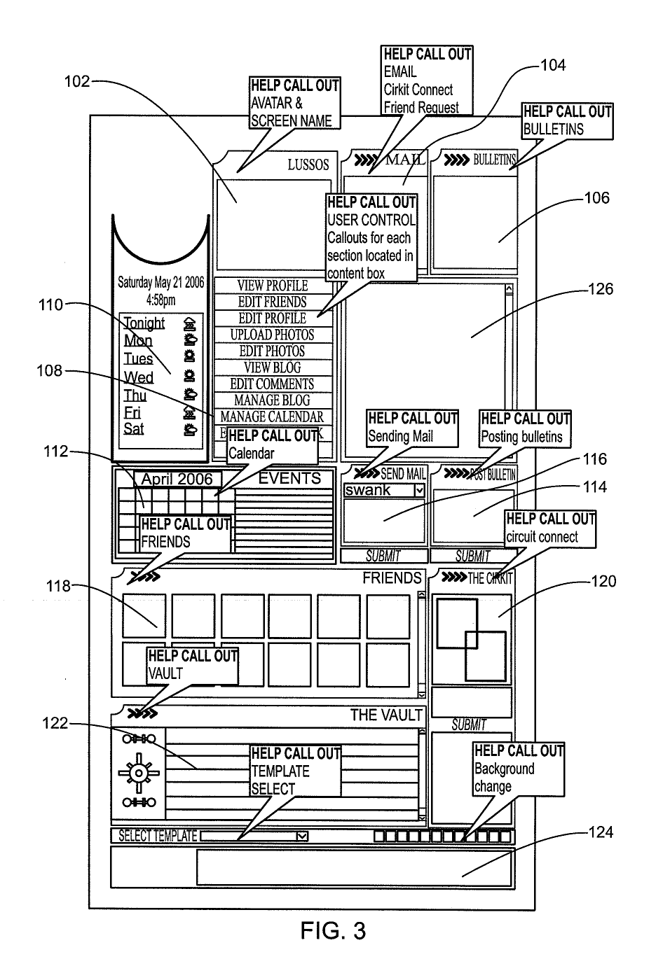

FIG. 3 is a schematic view of a user interface for use in accordance with an embodiment of the invention. FIG. 3 represents a sample dashboard/control page that a user interacts with to use a social networking website in accordance with an embodiment of the invention. The control page shown includes help callouts, which would ordinarily be hidden until a user moves his cursor over the related portion of the page. The control page contains many features useful to the user described in more detail below.

Friends box 118 contains a visual list of other users that the user considers friends. The avatars displayed in this box can be used to interact with the user it represents. For instance, in some embodiments, the user can begin a chat session with another user by hovering the mouse cursor over that user's avatar and selecting “chat with friend” from a popup menu. In some embodiments, other networking features can be utilized by interacting with a list of friends, such as messaging, file transfer, checking status of users or linking to their profile. In some embodiments, multiple friends boxes can be part of the interface, allowing friends to be grouped, classified, etc. In some embodiments, friends box 118 allows a user to organize his friends, such as reordering, grouping, prioritizing, customizing avatars, icons, images, or multimedia representations of friends. The friends box 118 can represent a users' friends/social group/social network.

Cirkit box 120 allows a user to send an invitation for two or more of his friends to meet by dragging their avatars into the cirkit box 120. The system allows the user to type a message to these users before sending a “hookup” request to the respective users as explained below. Other aspects of the dashboard depicted in FIG. 3 are described below.

A server for the social networking website facilitates the introduction of users by a mutually acquainted user. In some embodiments, a user interacts with an interface like that shown in FIG. 3 on a client, such as his web browser or mobile device that interacts with the server. In some embodiments of the interface, the user clicks and drags two avatars from his group of friends 118 or social network to a designated area on the screen, such as circkit box 120. Other embodiments allow the user to select friends in other manners, such as highlighting, clicking, or indicating to the interface in any appropriate manner, such as by touch screen on a mobile device. Once two friends have been selected and the user indicates he would like to form a cirkit, the client sends an indication of the selection to the server to introduce the two friends, such as by sending invitations to join each others social networks or groups of friends. The server can begin the introduction by forming a hookup object as described below.

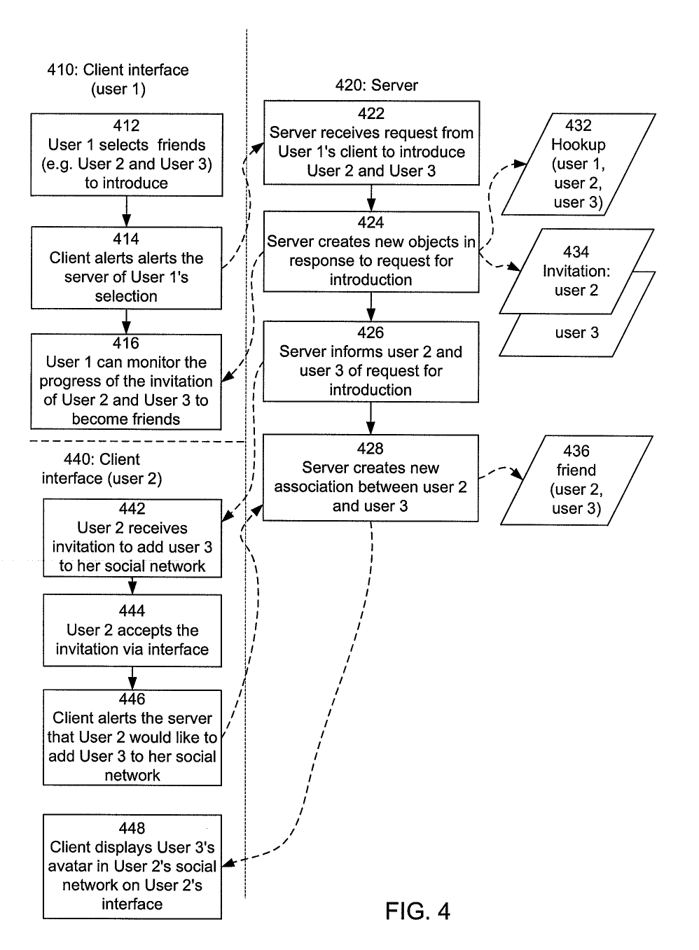

FIG. 4 is a flow chart of the operation of client and server components of an embodiment of a social networking system. FIG. 4 shows the interaction between the clients and the server to form a new cirkit between two friends of a new user in a system in accordance with certain embodiments. The first user, User 1, interacts to with the social networking system via an interface on a client 410, such as a web browser. In some embodiments, client interface 410 is presented to User 1 after he logs into his user account on the client or the server. Client interface 410 can have a layout similar to FIG. 3 or any other appropriate layout and can be customizable to suit User 1's tastes. At 412 User 1 indicates to the interface that he would like to form a new social connection or “cirkit” between User 2 and User 3. User 2 and User 3 can be friends in User 1's group of friends or part of one or more social networks that include User 1. In some embodiments, User 2 and User 3 do not know each other or are not part of the same social network or do not appear in a group of friends associated with the other. In some embodiments, User 2 and User 3 are preexisting members or users of the social networking system. In some embodiments, a server maintains a friend object that associates User 2 and User 1 and a friend object that associates User 3 and User 1.

User 1 can indicate that he would like to introduce User 2 and User 3 by, for instance, clicking and dragging avatars or action objects representing the users to a pre-selected position on the interface or by selecting an action button and selecting the two users via the interface. In some embodiments User 1 can select more than two other users (e.g. also selecting User 4, etc.) to introduce and could select any subset of other users to introduce. In some embodiments Users 2 or 3 could instead be a group of users such as club rather than a person. In some embodiments, User 1 can include a custom or pre-selected message as part of step 412 to include in an invitation to the selected users sought to be part of the new social connection. In some embodiments, User 1 can select his message prior to selection or be prompted by client interface 410 after selecting users to connect. In some embodiments, User 1 can select different messages to send to the selected users. In some embodiments, this message can be an email message.

At step 414, client interface 410 gathers appropriate information related to User 1's selection, such as an identification of Users 1, 2 and 3, a message to be included in any invitation to the invited users, and optionally an indication of the type of social connection, cirkit, or invitation sought or whether the connection should be immediately completed without confirmation by Users 2 and 3. Client interface then sends this information to a server 420 requesting a new cirkit or relationship be formed between the Users 2 and 3.

At step 416, client interface 410 can allow User 1 to monitor the progress of the invitation to Users 2 and 3. Client interface 410 can indicate status in any appropriate manner such as a progress bar, icon, text or by displaying a confirmation message such as an email. In some embodiments, Step 416 is initiated by User 1, and in other embodiments is performed automatically by client interface 410, and in other embodiments is performed by client interface 410 in response to new information from the server 420.

Server 420 handles, inter alia, requests to introduce users such as cirkit requests. At step 422 the server 420 receives a request to introduce Users 2 and 3 from User 1's client interface 410. Server 420 and client interface 410 can communicate in any appropriate manner, such as via a network such as the Internet or via a wireless network. At step 424, the server 420 prepares data objects to facilitate the introduction. For example, a hookup object 432 is created to record and monitor the request by User 1 to socially connect Users 2 and 3. In some embodiments, the social connection can be performed by server 420 without inviting Users 2 and 3 or without awaiting confirmation from Users 2 and 3 that they desire to be connected. In some embodiments, server 420 invites Users 2 and 3 to be connected and creates invitations, such as invitations 434. These can be objects or messages such as email.

In some embodiments, server 420 sends invitations to Users 2 and 3 at step 426. The server 420 can deliver the invitations in any appropriate manner such as by sending an email to an email account associated with each user or by preparing a message to be displayed on User 2's client interface 440 the next time she logs in. In some embodiments where User 1 can select more than two users to invite at step 412, server 420 can send out messages to each selected user. In embodiments where one selected user, such as User 2, is a group of users, server 420 can send invitations to all users in the group or to a designated subset, such as a group administrator as appropriate.

Once a connection between Users 2 and 3 is proper, server 420 connects the two users at step 428. In some embodiments, server 420 can automatically connect Users 2 and 3 without awaiting confirmation. In some embodiments, server 420 can connect Users 2 and 3 after awaiting confirmation from the User 2 and/or User 3, which the users can indicate via a client interface respectively associated with the invited user, such as User 2′ client interface 440. In some embodiments, confirmation can be via a confirmation email or by having User 2 or 3 visit a webpage. The server 420 can create a connection between User 2 and User 3 in any appropriate manner. In some embodiments, server 420 can create a friend object 436 representing the social connection between User 2 and User 3. In some embodiments, server 420 can create an entry in a database representing the social connection between User 2 and User 3. In some embodiments server 420 can add User 2 to a group or list associated with User 3 and vice versa. It will be appreciated that the general outcome of these embodiments is that at step 428, server 420 adds User 2 to User 3's friends/social group/social network and/or adds User 3 to User 2's friends/social group/social network such that User 2 and user 3 can interact socially.

Client interface 440 handles User 2's interaction with the social networking system. In some embodiments, client interface 440 is substantially similar to that displayed to User 1 in client interface 410 as described above. In some embodiments, client interface 440 is different from client interface 410, such as where client interface 440 operates on a mobile device and client interface 410 is displayed by a web browser on a PC. In some embodiments, client interface 440 and 410 can operate on a single computer at the same time or at separate times as User 2 and User 1 use that machine. In some embodiments, any combination of 410, 420, and 440 can operate on the same physical or virtual machine, device, or network In some embodiments 410, 420, and 440 can each include more than one device, machine, or network. In some embodiments, User 3 also interacts with a similar interface to client interface 440.

At step 442, client interface 440 receives an indication that User 1 wishes to introduce User 2 to User 3. This indication can be received in any appropriate manner such as part of a webpage shown to User 2 when she logs in or by receiving an asynchronous message from server 420 via a network or wireless link. Client interface 440 displays to User 2 an indication of the invitation to meet User 3. In some embodiments, where a connection is made automatically by the server in response to User 1's request, Client interface 440 displays an indication to User 2 that she has been added to User 3's friends/social group/social network and/or that User 3 has been added to User 2's friends/social group/social network.

At step 444, User 2 interacts with interface 440 to accept the invitation to add User 3 to User 2's friends/social group/social network and/or be added to User 3's friends/social group/social network. This interaction can be in any appropriate manner such as by clicking a button to accept.

At step 446, client interface 440 sends an indication to server 420 that User 2 has accepted the request to be socially connected to User 3. Server 420 can use this confirmation to complete the connection.

Once server 420 has completed the connection, client interface 440 can receive an indication that User 3 is now a friend of User 2. At step 448, client interface 440 displays to User 2 an indication that User 3 is part of User 2's friends/social group/social network. In some embodiments, step 448 is performed by displaying an icon, avatar, or other graphical representation of User 3's identity amongst other icons, avatars, or the like that are associated with other friend of User 2, such as the group displayed at 118. User 3 and any other users selected by User 1 at step 412 can have a similar interface experience to User 2. Once User 3 is added to User 2's friends/social group/social network, User 2 can then interact with User 3 for socialization. User 2 can further invite User 3 to meet other friends or contacts of User 2 by requesting a new social connection or cirkit by following steps similar to those depicted at 412.

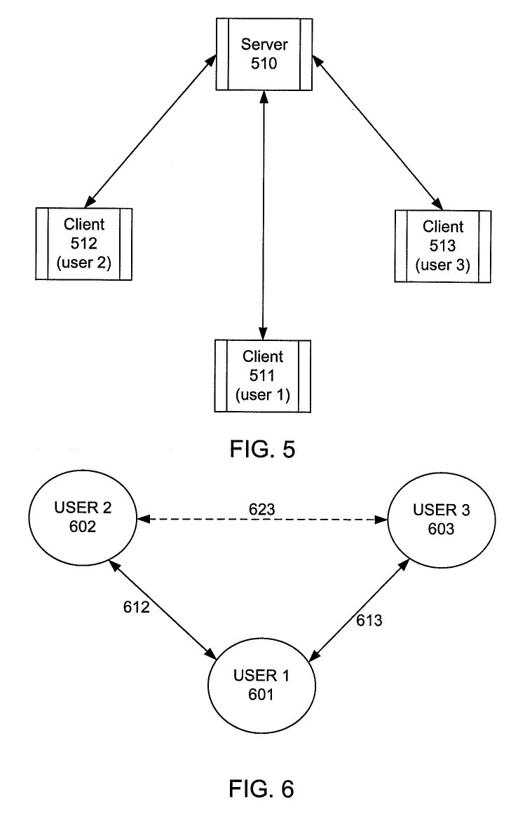

FIG. 5 is a schematic view of client and server components of an embodiment of a social networking system. Users 1, 2, and 3 operate clients that interact with a server 510. These clients 511, 512, and 513 can be web browsers, mobile devices, dedicated computers or other appropriate software or apparatus and can each be a different type of client or the same. For example, client 511 can be a web browser such as Microsoft® Internet Explorer® available from Microsoft Corporation or Mozilla® Firefox available from Mozilla Corporation operating on a first PC, client 512 can be a mobile device, such as a web enabled cell phone, and client 513 can be a web browser on a second PC or the first PC. Clients 511, 512, and 513 communicate with server 510 methods appropriate for the clients used, such as via IP over the Internet or other network or via a cellular communication system. In some embodiments, the system can include more clients than those illustrated.

Server 510 can be a computer or software running on a computer or other device. In some embodiments, server 510 is part of a general purpose web server. In some embodiments, can be a dedicated device or part of a device dedicate to the social networking system. In some embodiments, server 510 can be part of a device or computer that also includes at least one client, such as 511. Server 510 can maintain the data and objects related to users and relationships in the social networking system.

User 1 can introduce Users 2 and 3 by interacting with client 511 and sending a request for a social connection or cirkit to server 510. Server 510 can then invite or alert Users 2 and 3 by communicating with clients 512 and 513. If the system is configured to allow Users 2 and 3 to accept or decline the invitation, the respective clients 512 and 513 can send confirmation back to server 510. Server 510 can form the social connection between User 2 and User 3 in any chosen manner such as by adding User 2 to a group associated with User 3, and vice versa, which could include creating one or more friend objects to link the two users, as described below, or could include adding information to a database to link the users. Clients 512 and 513 can display the new relationship between User 2 and User 3 in an appropriate manner, such as by including graphical icons, avatars, text, or other identification that User 3 is part of User 2's friends/social group/social network.

FIG. 6 is a block diagram of data object for use with an embodiment of a social networking system. FIG. 6 depicts the relationships between Users 1, 2, and 3 in the social networking system. Each user can be represented in the system by user objects such as user objects 601, 602, and 603, respectively. Object 601 has a preexisting relationship 612 with 602, indicating that User 1 and User 2 are friends. Object 601 also has a preexisting relationship 613 with 602, indicating that User 1 and User 3 are friends. In some embodiments, relationships 612 and 613 can be represented by a friend object. In some embodiments, relationships 612 and 613 can be represented by a database relationship. In some embodiments, relationships 612 and 613 can have different attributes such as degree of relationship, basis, etc. Friend objects, in accordance with some embodiments of the invention are described below.

When User 1 uses the system to introduce User 2 and User 3, he requests that the system form relationship 623 which did not previously exist. In some embodiments, the social networking system will alert User 1 that relationship 623 has been previously formed. In some embodiments, the social networking system will alert User 1 when relationship 623 is formed. Relationship 623 can be formed in any of the manners disclosed herein.

As described above, FIG. 3 represents a sample dashboard/control page that a user interacts with to use a social networking website in accordance with an embodiment of the invention, and allows the user access to many features. User icon box 102 contains the user's avatar and username. Other users that add this user to their group of friend or favorites can include this avatar in a section, such as friends 118, of their control page. The avatar allows a graphical way to interact with users and show relationships.

Mail box 104 acts as an email inbox and contains a list of messages. When a user selects a message, for instance, by hovering the mouse cursor, the contents can be displayed in a callout, like the help bubbles shown or can be viewed in box 126. Display of the message occurs without refreshing the remainder of the page, for instance, by requesting the message contents from a server hosting the messages using an XmlHttpRequest object in accordance with Ajax methodology.

Bulletin board 106 acts as an announcement board to display announcements from friends and may contain a list of announcements. When a user selects an announcement, for instance, by hovering the mouse cursor, the contents can be displayed in a callout, like the help bubbles shown or can be viewed in box 126. Display of the announcement occurs without refreshing the remainder of the page.

Action list 108 provides a list of actions a user can select to use the system. For instance, the user can edit his address book by selecting the appropriate tab.

Information box 110 contains asynchronously updated information that can be configured by the user. For instance, information box 110 shows current weather information.

Calendar 112 displays appointments and the like.

Bulletin editor 114 allows the user to compose a bulletin and post it to his friends' bulletin boards. This box may be dynamically expanded when the user selects the box, allowing the user a larger typing area an display of formatting controls and the like only when editing a bulletin.

Email editor 114 allows the user to compose an email. This box may be dynamically expanded when the user selects the box, allowing the user a larger typing area and display of formatting controls and the like only when editing a email.

Vault 122 is a list of files that the user maintains on the system that can be shared with other users. In some embodiments, files and hierarchical folders are displayed and accessed in manner graphically similar to the Microsoft Windows operating system or other graphical file system that may be familiar to users.

Template selector 124 allows the user to select a skin or theme for his control page. Skins allow the user to customize his interface and may be preconfigured by other users or by the user applying the theme to his page.

To generate advertisement revenue, the system can also display ads on the control pages and personal profile pages of users. These ads may be static or dynamic banner-type ads. In some embodiments, the ads can be configured by the system to supply ads to the user such that he is consistently exposed to ads of a single brand for some duration of time, such as one month. This allows less obtrusive ads to have a greater overall effect on the user without frustrating the user.

The control page can also include a proxy web browser box or window that allows the user to view other web pages without navigating away from the current page. Because the pages being viewed can contain ads from other brands, the system can dynamically mask the ads that normally appear on the user's control page. This allows the system to prevent the ads of its advertiser clients from being displayed in association with unknown content and these ads from being displayed when competing ads are displayed by the proxy web browser. In some embodiments, the proxy web browser can be run at the server (e.g. a true proxy) or on the user's client machine. Using a proxy web browser where the server of the social networking site acts as a client and sends the pages to the user's client machine may allow for anonymous web browsing or may allow the server to filter malicious content.

### Features

A social networking system in accordance with an embodiment of the invention can provide the user with email capabilities. Checking email can be a one-click process that enables users to scroll their inbox, gain an instant preview, open, read and reply to emails without ever leaving a main control panel page. The system can keep users of the website engaged and retained while other sites frustrate their users resulting in devalued advertisements. Network email can also used as an intra site notification system, and communicate with the user's native email account.

A social networking system in accordance with an embodiment of the invention can allow the user to send out an announcement to selected users or all users in their network. Common announcements can include party invitations, press releases, birth announcements, record releases, family news, board meetings.

A social networking system in accordance with an embodiment of the invention can provide users of a social networking website with a hundreds of megabytes of permission based file storage space that enables the exchange of files that are too large for conventional email services. This allows exchanging files, such as high resolution photographs, large architectural blueprints to video files and home movies, with a user's friends, family, colleagues, and co-workers.

In some embodiments, introducing two people can be performed easily by a user. A user can drag and drop avatars or pictures of members of his network (e.g. friends, colleagues) into a connection-box, type a message and submit. An introduction (sometimes referred to as a “hookup”) is made that can be applied to business, socializing, dating or any other type of partnership. This introduction can be instant and/or graphical. In some embodiments, both members can receive an email or an alert message from the matchmaker which enables them to approve or decline to accept the other member user into their personal network. In some embodiments, this can be considered a handshake without meeting someone in person. The hookup allows both members receiving the introduction to feel comfortable with the introduction because they both know and trust the user making the introduction. In some embodiments, the matchmaker can also monitor the progress of the hookup, for instance enabling the matchmaker to follow up with his friends if one of them declines the invitation to meet online.

A social networking system in accordance with an embodiment of the invention can enable users to display their photos in a scrollable gallery located on their profile page. In some embodiments, images can be previewed and enlarged without having to refresh or load an entire page. Members of the users network can add remarks to any photo, and the user has the ability to reply and/or delete the remark. In some embodiments, users can order prints of any photos in a gallery.

A social networking system in accordance with an embodiment of the invention can enable users to easily add videos to their profile page that are hosted from all of the popular video websites like youtube.com and the like, or videos hosted on their own servers by simply pasting the web address of the video and assigning a video title.

A social networking system in accordance with an embodiment of the invention can enable users to easily add songs that can be listened to by other members individually or as part of “radio” station of member music.

In some embodiments, members of a user's friends/social network/social group can add a remark to a user's personal profile page. Remarks can contain photos, movies, and other multimedia as well as rich text. The profile owner can reply to the remark, as well as the ability to edit, delete, decline, or accept the remark.

In some embodiments, users can use a journal style chronological blogging system for providing commentary on topics and events.

In some embodiments, users can share favorite web links with their friends/social network/social group, allowing other users to quickly add the bookmarks to their own profiles.

In some embodiments, can send announcements to their friends/social network/social group with personal news. For instance, users can send bulletins to friends or post the news in a breaking news section of their personal profile page. World news, such as news received from RSS feeds from popular news outlets can also be displayed for users.

In some embodiments, users can display their advice on whatever subject they deem fit on their personal profile pages.

In some embodiments, users are able to keep track of events, meetings, parties, and the like, using drag and drop functionality. This feature can provide complete integration with the rest of the system's feature set.

In some embodiments, a user can use a “for sale” section on his personal profile page. The user can also send bulletins reflecting the post to his friends. The user can post a picture, a description, and a price of his item, and members of his friends/social network/social group can contact him directly to initiate the transaction.

In some embodiments, users can post their resumes, bios, or accomplishments in a preconfigured section of their personal profile pages.

In some embodiments, a user's information is displayed to the social networking community in different category types in a preconfigured section of the user's personal profile page. Information can be segmented for personal and business use. A personal user can display information such as Favorite TV shows and music. A business profile can contain a mission statement and company news, a band's profile would contain album releases, tour information and other relevant information. A details category can provide a snapshot of information relevant to the user. A personal accounts category can contain data such as gender, age, and marital status. A Business accounts can contain business type and location.

In some embodiments, users with mutual interests can communicate freely in a message board system, segmented by several categories that accommodate the masses. The message board can be implemented using Ajax programming techniques. Users can create and manage their own clubs.

In some embodiments, users can customize the look of their entire profile using the user interface. From using a custom photo, or change the entire look and feel on the fly by selecting a themed template. Along with offering several templates, the system can offer customized sponsored templates as well as user submitted templates that have been approved by a design team. In some embodiments, the design of the user's pages can change, but the uniformity of all the site functionality is not affected by the customization.

In some embodiments, a system can rank a member user based on referrals, participation, network size, and several other variables. Users can be rewarded with tangible rewards for achieving a higher member ranking.

### Object Model

In some embodiments an object model is used to implement the social networking system. In some embodiments, the social networking system is a website. An object oriented approach allows simplified manipulation and association of data. A person of ordinary skill in the art will appreciate that the system could be implemented using alternative methodologies including using databases.

In some embodiments the central object representing each user is the user object. Each user object is an instance of the user class and contains the personal identification information for a registered user. A user object has the following attributes: user_id, a unique integer for referring to the user by the system; first_name, a variable character field; middle_name, a variable character field; last_name, a variable character field; display_name, a variable character field; tag_line, a variable character field containing a short personal phrase; create_date, a date/time variable containing the creation date of the user's account; last_access_date, a date/time variable containing the date the user last accessed his account; active, a Boolean indicating whether the user account is enabled; admin, a Boolean indicating if the user has administrative privileges; email, a variable character field that contains an email address; passwd, a variable character field that contains the user's password; user_details_id, and integer indicating the unique user details object associated with the user; and external_email, a Boolean indicating whether email should be forwarded to external email accounts.

In some embodiments, information about the user, such as his weight, height, smoking preference, etc. is stored in a user_details object. Each user object refers to an associated user_details object by the user_details_id field. The user_details class contains the following attributes: user_details_id, a unique value; orientation_id, an integer indicating the sexual orientation of the user; zodiac_id, an integer indicating the user's zodiac sign; education_id, an integer indicating the user's highest level of education; country_id, an integer indicating the user's country; state_id, an integer indicating the user's state or province if the user resides in an appropriate country; religion_id, an integer indicating the user's religion; ethnicity_id, an integer indicating the user's ethnicity; body_type_id, an integer indicating the user's body type, such as skinny; income_id, an integer indicating the user's income level or range; status_id, an integer indicating the user's marital status; children_id, an integer indicating the user's number of issue; sex, a character indicating the user's gender; age, an integer indicating the user's age; smoke, an integer indicating the user's smoking habits; drink, an integer indicating the user's drinking habits; height, an integer or string indicating the user's height; weight, an integer or string indicating the user's weight; occupation, a variable character string indicating the user's occupation; birthday, a date/time variable indicating the user's birthday; hometown, a variable character string indicating the user's hometown; and reasons_id, an integer indicating the user's reason for joining the site, such meeting friends or searching for romance. At registration, the user may fill out these fields, choosing to leave some blank. The user may also modify these fields later, after registration. Generally, these_id fields, such as religion_id act as references to objects shared by all users, which typically contain a displayable string, such as “Catholic.” Some objects referred to by ids, such as state_id and country_id, also include an abbreviation attribute. By using id's rather than strings within each user_details object, the system requires significantly less memory to store information that is the same amongst many members.

In some embodiments, information about the user's interests that may be customized by the user for display on his personal profile page is contained in a user's personal_information object, which contains the following attributes: user_interests_id, a unique integer for referring to the user_interests object; user_id, an integer identifying the user having interests; and a series of customizable text fields, such as movies, tv shows, books, idols, music, types of people they like, and other interests.

In some embodiments, a user can update his information from his personal profile page after registration. When he submits changes to his profile, each change creates a user_config object that can be used by the system to change the attributes of the user or any of the users associated fields. The user_config object contains the following fields: user_config_id, a unique integer for referring to the user_config object; user_id, an integer identifying the user being updated; name, a variable character field identifying the name of the attribute to be changed; and value, a text field containing the new value for the attribute to be changed. Ordinarily the system will fill the user_config attributes in response to a form submission by the user, but other methods of populating and creating user_config attributes can be used. Other configurable features include the display theme of the page or other options that allow the user to enjoy a custom web experience as would be commonly understood.

In some embodiments, the system also has photo, music and video objects that contain audio-visual content that can be displayed on or linked to from a user's personal profile page and can also be shared between users. These content objects can be used by users that are successful or aspiring musicians or directors to display and share their content through the networking website. These objects can also be used to simply customize a user's personal profile page. The photo object class contains the following attributes: photo_id, a unique integer that may be used to refer to the photo object; name, a variable character string containing the title of the image; path, a variable character field containing the location, such as URL of the content; create_date, a date/time variable indicating when the image was created or added to the website; tags, a text field that can be used to add a brief keywords about the photo; thumbnail_Path, a variable character field containing the location, such as URL of a thumbnail photo that links to the actual, full-resolution photo; photos_type_id, an integer that refers to one of a group of shared photos_type objects that each contain a variable character field indicating a photo type, such as avatar, advertisement, or high resolution photo; and user_id, an integer that refers to the user that controls the photo object. The music object class contains the following attributes: music_id, a unique integer that may be used to refer to the music object; name, a variable character string containing the title of the track; path, a text field containing the location, such as URL of the content; create_date, a date/time variable indicating when the track was created or added to the website; and user_id, an integer that refers to the user that controls the music object. The video object class contains the following attributes: video_id, a unique integer that may be used to refer to the video object; name, a variable character string containing the title of the clip; path, a text field containing the location, such as URL of the content; create_date, a date/time variable indicating when the clip was created or added to the website; and user_id, an integer that refers to the user that controls the video object.

To enable the artisan community to gain feedback on their work from friends and fans, In some embodiments, the system supports comment objects that can be associated with the video, music, and photo objects. These comment objects are typically created by other users upon viewing or listening to the content through the networking website. The photo_comments object class contains the following attributes: photo_comments_id, a unique integer to identify the photo comment object; photo_id, an integer that refers to the photo being commented on; commenter_user_id, an integer matching the user id of the commenting user; subject, a text field containing the title of the comment; comment, a text field containing the body of the comment; create_date, a date/time variable indicating when the photo comment was created or added to the website; response_id, an integer referring to a response object that may be added in response to the comment; approved, a Boolean that indicates whether the comment has been approved for public display or rejected by the user. The music_comments object class contains the following attributes: music_comments_id, a unique integer to identify the music comment object; music_id, an integer that refers to the music track being commented on; commenter_user_id, an integer matching the user id of the commenting user; subject, a text field containing the title of the comment; comment, a text field containing the body of the comment; create_date, a date/time variable indicating when the photo comment was created or added to the website; response, a Boolean indicating that a response has been posted to the comment; response_id, an integer referring to a response object that may be added in response to the comment; approved, a Boolean that indicates whether the comment has been approved for public display or rejected by the user. The video_comments object class contains the following attributes: video_comments_id, a unique integer to identify the video comment object; video_id, an integer that refers to the video clip being commented on; commenter_user_id, an integer matching the user id of the commenting user; subject, a text field containing the title of the comment; comment, a text field containing the body of the comment; create_date, a date/time variable indicating when the photo comment was created or added to the website; response, a Boolean indicating that a response has been posted to the comment; response_id, an integer referring to a response object that may be added in response to the comment; approved, a Boolean that indicates whether the comment has been approved for public display or rejected by the user.

In some embodiments, the system also includes user comment objects, allowing other users to comment on other users. These comments can be displayed on that user's personal profile page and used as a personal public conversation about and with the user. The user_comments object class contains the following attributes: user_comments_id, a unique integer to identify the user comment object; user_id, an integer that refers to the user being commented on; commenter_user_id, an integer matching the user id of the commenting user; subject, a text field containing the title of the comment; comment, a text field containing the body of the comment; create_date, a date/time variable indicating when the photo comment was created or added to the website; response, a Boolean indicating that a response has been posted to the comment; response_id, an integer referring to a response object that may be added in response to the comment; approved, a Boolean that indicates whether the comment has been approved for public display or rejected by the user.

Besides comments, other objects are associated with a user within the system. For instance, In some embodiments, there are objects that create a group of friends associated with the user. These groups can be displayed, for instance, as part of the user's personal profile page along with icons and names of the user's closest friends, who are also users. A separate friend object is created for each friendly association, allowing the user to record a friendly relationship with another user. The friend class contains the following fields: friends_id, a unique integer to identify the friend object; user_id, an integer that refers to the user that controls the friend object; friend_user_id, an integer matching the user id of the user's friend; create_date, a date/time variable indicating when the friend object was created or added to the website. Favorites objects work in much the same way as friend objects, containing the same fields. This allows users to indicate both acquaintances and close friends, for instance. In some embodiments, the user controls which groups (e.g. friends) will be displayed on the user's public page.

In some embodiments, another group of users that operates like friends and favorites, but having an opposite meaning, is a blocked group. A user may block other users from sending messages, viewing the user's personal information, or any other level of restriction that may be appropriate by adding users to be blocked to the blocked group. Each time a user blocks another user, the system creates and maintains a blocks object containing the following attributes: blocks_id, a unique integer for referring to the blocking association; user_id, an integer for referring to the user blocking another user; blocks_user_id, an integer for referring to the blocked user; and create_date, a date/time variable indicating when the blocking association was created.

In some embodiments, the system also allows users to be ranked. Each user ranking is recorded in an ranking object that associates a rank with a user, such as for indicating community sentiment about a user or popularity. The ranking class contains the following attributes: ranking_id, a unique integer to identify the user ranking object; user_id, an integer that refers to the user being ranked; and rank, an integer indicating the rank of the user. In some embodiments, rank will be a unique number, in others it may be indicative of a class of users, such as popular or unpopular, like a star rating for hotels, and can be indicative of attributes of the user, such as how frequently other users visit their page, or how often other users find the user's comments useful.

In some embodiments, the system encourages users to communicate with one another and provides multiple ways of sending messages to each other, including posting comments (about users, photos, videos, music, events, blogs) sending emails to each other, sending short bulletin messages to each other, posting messages to forums and newsgroups, and creating hookups using the cirkit feature. Emails are stored on the system as email objects that can be linked together to form a conversation. When a user emails another user of the system, an email object is created that can then be accessed by the recipient. The email class contains the following attributes: email_id, a unique integer identifying the object; from_user_id, an integer that refers to the user sending the email; to_user_id, an integer that refers to the user receiving the email; create_date, a date/time variable indicating when the email was created; respond_date, a date/time variable indicating when the email was responded to by the recipient; subject, a variable character field containing the subject; data, a text field containing the message body; spam, a Boolean indicating if the message is spam; viewed, a Boolean indicating that the recipient has read the message; previous_id, an integer indicating the previous email in the conversation; trashed, a Boolean indicating that the email has been placed in a trash buffer; and deleted, a Boolean indicating that the message has actually been deleted. By using recipient and sender user_id fields in the email object, extra-system emails can also be facilitated. This email system can be adapted to facilitate internal emails from the community, externally received email, externally sent email, email forwarding and the like.

In some embodiments, an alternative to email is a bulletin, which is a short message that will appear as an announcement to a group of friends or your entire network. Each bulletin on a user's personal profile page has a user_bulletin object that includes: user_bulletin_id, a unique integer id; from_user_id, an integer that refers to the user sending the bulletin; to_user_id, an integer that refers to the user receiving the bulletin; viewed, a Boolean indicating that the recipient has read the message; email_bulletin_id, an integer referring to an email_bulletin object that contains the bulletin data; and respond_email_bulletin_id, an integer referring to an email_bulletin object that contains the bulletin data for the response. Each email_bulletin object includes: email_bulletin_id, a unique integer identifying the object; create_date, a date/time variable indicating when the email was created; subject, a variable character field containing the subject; and data, a text field containing the message body.

In some embodiments, users may also communicate through group bulletins and forums. Groups can be created to meet the needs of the users, such private groups of friends or public groups based on common interest. Each group object contains the following attributes: groups_id, a unique integer for referring to the group object; user_id, an integer referring to the user that created the group; group_category_id, an integer referring to a group_category object that contains a variable character name field; create_date, a date/time variable indicating when the group was created or added to the website; open_join, a Boolean that indicates whether other users can join without invitation; hidden, a Boolean that indicates that the group is publicly displayed; city, a variable character field that indicates where, if anywhere, the group is principally located; zip, a variable character field that indicates where, if anywhere, the group is principally located; region, a variable character field that indicates where, if anywhere, the group is principally located; short_desc, a variable character field that contains a brief thumbnail-type description for display when users search or browse groups; long_desc, a text field that contains a full length description of the group identity; url a variable character field that contains the group's website; country_id, an integer that indicates where, if anywhere, the group is principally located; state_id, an integer that indicates where, if anywhere, the group is principally located.

In some embodiments, bulletins can be sent to the group by members. When bulletins are submitted by a user, a bulletin object is created that allows the bulletin to be displayed to other members. The bulletin object class contains: bulletin_id a unique integer for referring to the bulletin object; user_id, an integer referring to the user sending the bulletin; groups_id, an integer indicating the group receiving the bulletin; subject, a variable character field containing the title of the bulletin; body, the text of the bulletin; and create_date, a date/time variable indicating when the bulletin was created.

In some embodiments, users can also post to a group forum. Each conversation in the forum is called a topic (or thread) and within each topic, there can be multiple topic posts. Topics are represented by topic objects, which contain: topic_id, a unique integer for referring to the topic object; user_id, an integer that refers to the user creating the topic; name, a variable character field containing the title of the topic; num_posts, an integer indicating how many topic_posts have been added to the topic by users; last_post, a date/time variable indicating when the last topic_post was created; create_date, a date/time variable indicating when the topic was created; groups_id, an integer indicating the group forum being posted to; description, a text value describing the topic. Each topic post associated with a topic is represented by a separate topic_post object containing: topic_post_id, a unique integer for referring to the topic_post object; topic_id, an integer that refers to the topic the topic_post is attributed to; user_id an integer that refers to the user creating the topic_post; message, the text of the topic_post; and create_date, a date/time variable indicating when the topic_Post was created.

In some embodiments, users can also communicate by maintaining a blog (i.e. web log) on their personal profile page or in an area of the website devoted to blogs, allowing them to keep a journal for friends or the public to view. Blog entries are represented on the system by a blog object, containing the following attributes: blog_id, a unique integer for referring to the blog entry object; user_id, an integer that refers to the user creating the blog entry; name, a variable character field containing the title of the entry; data, the text of the blog entry; create_date, a date/time variable indicating when the blog entry was created; last_viewed_date, a date/time variable indicating when the blog entry was last viewed by others; visitor_count, an integer that tracks how many users have viewed the entry; category_id, an integer that refers to a blog_category object containing a title of a category of blog entries, such as “politics”; and privacy_id, an integer that refers to a privacy object containing the category of other users that can view the blog, such as “public” or “favorites.” Readers of a blog entry can comment on the entry. This creates a blog_comment object containing: blog_comment_id, a unique integer for referring to the comment object; user_id, an integer that refers to the user creating the comment; blog_id, an integer that refers to the blog entry that the comment is about; response_id, an integer referring to a response object that may be added in response to the comment; subject, a variable character field containing the title of the comment; comment, the text of the comment; create_date, a date/time variable indicating when the comment was created.

The system also can include a contact manager, including a user's address book. Each user can have an collection of address book entries associated with the user. The addresses object class has the following attributes: addresses_id, a unique integer for referring to the address object; user_id, an integer for referring to the user associated with the address book; contact_user_id, an integer for referring to the user whose details are contained in the address object; first_name, a variable character field; middle_name, a variable character field; last_name, a variable character field with a maximum size of 100; user_name, a variable character field; email, a variable character field that contains an email address; alt_email, a variable character field that contains an alternate email address; alt_email2, a variable character field that contains an alternate email address; create_date, a date variable containing the creation date of the addressbook entry; phone, a variable character field containing a phone number; phone_type_id, an integer referring to a phone type object containing text about the type of phone (e.g. mobile); alt_phone, a variable character field containing an alternate phone number; alt_phone_type_id, an integer referring to a phone type object containing text about the type of phone; alt_phone2, a variable character field containing an alternate phone number; alt_phone2_type_id, an integer referring to a phone type object containing text about the type of phone; and note, a text field allowing the user to create a note to associate with the contact.

Users can also use the system to create electronic invites to events, such as parties or meetings. In some embodiments, when a user wants to organize an event, the system creates an event object representing the planned event. In some embodiments the event object class contains the following attributes: events_id a unique integer for referring to the event object; user_id, an integer for referring to the user planning the event; create_date, a date/time variable containing the creation date of the event; event_date, a date/time variable containing the date of the event; name, a variable character title for the event; short_desc, a variable character summary for the event; place, a variable character location for the event; address, a variable character location for the event; city, a variable character location for the event; zip, a variable character location for the event; contact_email, a variable character email address for more information about the event; long_desc, text describing the event and invite; guests_per_invite, an integer capping the number of guests that can attend for each invite; guest_list_visible, a Boolean making the guest list visible to other invitees; private, a Boolean that hides the event from users not invited; event_category_id, an integer that refers to a category object containing the name of a category of events, such as “party”; event_comments_gracl_id, an integer that refers an event_comment_acl object that contains comments; state_id, an integer that refers to a state object holding the name of the state of the event; country_id, an integer that refers to a state object holding the name of the country of the event; and photo_id, an integer that refers to a photo to be displayed in association with the event, such as on invitations. Users may also comment on events, for instance, congratulating the event organizer. Comments about events are stored as event_comments objects that contain the following attributes: event_comments_id a unique integer for referring to the event comment object; events_id, an integer for referring to the event object; user_id, an integer for referring to the user making the comment; response_id, an integer referring to a response object that may be added in response to the comment; subject, a variable character field containing the title of the comment; comment, the text of the comment; create_date, a date/time variable indicating when the comment was created. When an event is created, the user sends invitations to other users, creating event_invites objects that contain the following attributes: event_invite_id, a unique integer for referring to the invite; user_id, an integer for referring to the user being invited; event_invites_status_id, an integer referring to a event_invites_status object that contains text describing a common status for the invitation, such as “accepted”; email, a variable character field that contains an email address of the invitee; create_date, a date/time variable containing the creation date of the invite; and date_responded, a date/time variable containing the date the invitee responded.

In some embodiments, event object class contains the following attributes: event_id a unique integer for referring to the event object; user_id, an integer for referring to the user planning the event; date, a date/time variable containing the date of the event; name, a variable character title for the event; name, a name for the event; location, the place of the event; long_desc, a paragraph describing the event; event_category_id, a reference to an object containing the type of event, such as birthday.

Users can take advantage of the community orientation of the networking system by introducing their friends and peers by forming a hookup or “cirkit.” In some embodiments, when a user chooses to make an introduction between two other users, the user selects these other users and the system creates a hookup object that contains the following fields: hookups_id a unique integer for referring to the hookup object; user_id, an integer for referring to the user suggesting the cirkit; friend1_id, an integer for referring to the first user referred to by the cirkit; friend2_id, an integer for referring to the second user referred to by the cirkit; message, a text field that the user suggesting the cirkit can fill in that contains a message to be sent to the two friends forming the cirkit; create_date, a date/time variable indicating when the cirkit was created; accepted_date1, a date/time variable indicating when the first user referred to by the cirkit accepted the invitation to meet the second user referred to by the cirkit, if accepting; rejected_date1, a date/time variable indicating when the first user referred to by the cirkit declined the invitation to meet the second user referred to by the cirkit, if declining; rejected_reason1, a text field that allows the first user referred to by the cirkit to explain why he declined the cirkit; accepted_date2, a date/time variable indicating when the second user referred to by the cirkit accepted the invitation to meet the first user referred to by the cirkit, if accepting; rejected_date2, a date/time variable indicating when the second user referred to by the cirkit declined the invitation to meet the first user referred to by the cirkit, if declining; and rejected_reason2, a text field that allows the second user referred to by the cirkit to explain why he declined the cirkit.

In some embodiments, hookups/cirkits progress can be monitored by a user, for instance the matchmaker or an interested party, when the system creates a hookups_progress object. A hookups_progress object has the following attributes: hookups_progress_id, a unique integer for referring to the progress object; user_id, an integer for referring to the user monitoring the hookup; hookups_progress_type_id, an integer referring to a hookups_progress_type object that contains text describing a common status for the invitation, such as “accepted by both”; note, a text field allowing the user to associate note with the hookup/cirkit being monitored; and create_date, a date/time variable containing the creation date of the invite. The hookup invite creates an email that includes several possible states that change as the progress changes, such as not read.

The above-described systems and methods can be implemented in digital electronic circuitry, in computer hardware, firmware, and/or software. The implementation can be as a computer program product (i.e., a computer program tangibly embodied in an information carrier). The implementation can, for example, be in a machine-readable storage device and/or in a propagated signal, for execution by, or to control the operation of, data processing apparatus. The implementation can, for example, be a programmable processor, a computer, and/or multiple computers.

A computer program can be written in any form of programming language, including compiled and/or interpreted languages, and the computer program can be deployed in any form, including as a stand-alone program or as a subroutine, element, and/or other unit suitable for use in a computing environment. A computer program can be deployed to be executed on one computer or on multiple computers at one site.

Method steps can be performed by one or more programmable processors executing a computer program to perform functions by operating on input data and generating output. Method steps can also be performed by and an apparatus can be implemented as special purpose logic circuitry. The circuitry can, for example, be a FPGA (field programmable gate array) and/or an ASIC (application-specific integrated circuit). Modules, subroutines, and software agents can refer to portions of the computer program, the processor, the special circuitry, software, and/or hardware that implements that functionality.

Processors suitable for the execution of a computer program include, by way of example, both general and special purpose microprocessors, and any one or more processors of any kind of digital computer. Generally, a processor receives instructions and data from a read-only memory or a random access memory or both. The basic elements of a computer are a processor for executing instructions and one or more memory devices for storing instructions and data. Generally, a computer can include, can be operatively coupled to receive data from and/or transfer data to one or more mass storage devices for storing data (e.g., magnetic, magneto-optical disks, or optical disks).

Data transmission and instructions can also occur over a communications network. Information carriers suitable for embodying computer program instructions and data include all forms of non-volatile memory, including by way of example semiconductor memory devices. The information carriers can, for example, be EPROM, EEPROM, flash memory devices, magnetic disks, internal hard disks, removable disks, magneto-optical disks, CD-ROM, and/or DVD-ROM disks. The processor and the memory can be supplemented by, and/or incorporated in special purpose logic circuitry.

To provide for interaction with a user, the above described techniques can be implemented on a computer having a display device. The display device can, for example, be a cathode ray tube (CRT) and/or a liquid crystal display (LCD) monitor. The interaction with a user can, for example, be a display of information to the user and a keyboard and a pointing device (e.g., a mouse or a trackball) by which the user can provide input to the computer (e.g., interact with a user interface element). Other kinds of devices can be used to provide for interaction with a user. Other devices can, for example, be feedback provided to the user in any form of sensory feedback (e.g., visual feedback, auditory feedback, or tactile feedback). Input from the user can, for example, be received in any form, including acoustic, speech, and/or tactile input.

The above described techniques can be implemented in a distributed computing system that includes a back-end component. The back-end component can, for example, be a data server, a middleware component, and/or an application server. The above described techniques can be implemented in a distributing computing system that includes a front-end component. The front-end component can, for example, be a client computer having a graphical user interface, a Web browser through which a user can interact with an example implementation, and/or other graphical user interfaces for a transmitting device. The components of the system can be interconnected by any form or medium of digital data communication (e.g., a communication network). Examples of communication networks include a local area network (LAN), a wide area network (WAN), the Internet, wired networks, and/or wireless networks.

The system can include clients and servers. A client and a server are generally remote from each other and typically interact through a communication network. The relationship of client and server arises by virtue of computer programs running on the respective computers and having a client-server relationship to each other.

Networks utilized by the system can include, for example, the Internet, a carrier internet protocol (IP) network (e.g., local area network (LAN), wide area network (WAN), campus area network (CAN), metropolitan area network (MAN), home area network (HAN)), a private IP network, an IP private branch exchange (IPBX), a wireless network (e.g., radio access network (RAN), 802.11 network, 802.16 network, general packet radio service (GPRS) network, HiperLAN), and/or other packet-based networks. Circuit-based networks can include, for example, the public switched telephone network (PSTN), a private branch exchange (PBX), a wireless network (e.g., RAN, bluetooth, code-division multiple access (CDMA) network, time division multiple access (TDMA) network, global system for mobile communications (GSM) network), and/or other circuit-based networks.

Clients used by the system can include, for example, a computer, a computer with a browser device, a telephone, an IP phone, a mobile device (e.g., cellular phone, personal digital assistant (PDA) device, laptop computer, electronic mail device), and/or other communication devices. Browser devices that can be used with embodiments of the invention include, for example, a computer (e.g., desktop computer, laptop computer) with a world wide web browser (e.g., Microsoft® Internet Explorer® available from Microsoft Corporation, Mozilla® Firefox available from Mozilla Corporation). Mobile computing device that can be used with the embodiments of invention include, for example, a Blackberry®.

Comprise, include, and/or plural forms of each are open ended and include the listed parts and can include additional parts that are not listed. And/or is open ended and includes one or more of the listed parts and combinations of the listed parts.

One skilled in the art will realize the invention may be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

What is claimed is:

1. A method for enabling electronic introductions of users of an online community comprising, at a client, steps of:
displaying a client interface to a first user that presents a plurality of displayable user objects, each of the plurality of displayable user objects representing at least one member of a group of users associated with the first user;
receiving from the first user a selection of at least two of the plurality of displayable user objects representing at least two members of the group of users associated with the first user;
receiving a first user action through the client interface to initiate an association between the plurality of users; and
sending a request to a server to initiate an electronic introduction between the plurality of users.

2. The method of claim 1, further comprising the step of indicating to a second user, who is one of the plurality of users, that the first user would like to introduce the second at least another of the plurality of users.

3. The method of claim 2, further comprising the step of enabling the second user to confirm that she would like to at least another of the plurality of users as a member of to a group of users associated with the second user.

4. The method of claim 3, wherein the step of enabling the second user to confirm includes enabling the second user to confirm via the client interface.

5. The method of claim 1, further comprising the step of indicating to a second user, who is one of the plurality of users, that at least another of the plurality of users has been added as a member of to a group of users associated with the second user.

6. The method of claim 1, wherein the user action includes manipulation of a drag and drop interface.

7. The method of claim 1, wherein the client interface includes a web page.

8. The method of claim 7, wherein the web page communicates asynchronously with the server.

9. A method for enabling electronic introductions of users of an online community comprising, at a server, steps of:
maintaining information that associates at least a first group of users with a first user, a second group of users with a second user, and a third group of users with a third user;
receiving at a server a request to initiate an electronic introduction between a subset of members of the first group including at least the second user and the third user; and
updating the information to include the third user in the second group.

10. The method of claim 9, further comprising the step of creating a record of the request on the server.

11. The method of claim 10, wherein record of the request allows the first user to monitor a status of the request.

12. The method of claim 9, wherein the step the second user is informed of the request via at least one invitation to join the third group.

13. The method of claim 11, wherein the step of updating information is not performed until the second user accepts the invitation.

14. The method of claim 9, wherein the step the second user is informed of the request via at least one invitation to add the third user to the second group.

15. The method of claim 11, wherein the step of updating information is not performed until the second user accepts the invitation.

16. The method of claim 9, wherein the first, second, and third groups are groups of social contacts associated with the first, second, and third users respectively.

17. A method for enabling electronic introductions of users of an online community comprising steps of:
Displaying a web interface to a first user that presents a plurality of displayable user objects, each of the plurality of displayable user objects representing at least one member of a first social network associated with the first user;
enabling the first user to select at least two of the plurality of displayable user objects, wherein the selection indicates a plurality of users that are part of the first user's social network;
receiving a from the first user via the web interface a request to introduce the plurality of users;
adding at least one of the plurality of users to a second social network associated with a second user, who is among the plurality of users.

18. The method of claim 17, further comprising the step of indicating to at least the second user that the first user would like to introduce the second to at least one of the plurality of users.

19. The method of claim 18, further comprising the step of enabling the second user to confirm that she would like to add a third user to the second social network, wherein the third user is among the plurality of users.

20. The method of claim 19, further comprising the step of adding the second user to a third social network associated with a third user.

21. The method of claim 17, further comprising the step of indicating to the second user that the third user has been added to a social network associated with the second user.

22. The method of claim 17, further comprising the step of creating a record of the request on a server such that the first user to can monitor a status of the request.

23. The method of claim 17, further comprising the step of sending at least one invitation to the second user and a third user in response to first user's manipulation via a web browser displayable user objects representing the second and third users.

24. The method of claim 17, wherein the step of receiving the request occurs in response to detecting that the user has dragged and dropped the selection of user objects.

25. The method of claim 17, wherein the web interface communicates asynchronously with a server.
